(19) United States
(12) Patent Application Publication
(10) Pub. No.: US 2024/0085573 A1
(43) Pub. Date: Mar. 14, 2024

(54) VEHICLE COMPRISING A DATA COLLECTION UNIT

(71) Applicant: KTM AG, Mattighofen (AT)

(72) Inventor: Christian SCHAIDREITER, Salzburg (AT)

(21) Appl. No.: 18/367,788

(22) Filed: Sep. 13, 2023

(30) Foreign Application Priority Data
Sep. 14, 2022 (AT) A 50706/2022

(51) Int. Cl. G01S 19/36; B62J 43/30; B62J 45/41; B62J 45/423; H04B 3/04

(52) U.S. Cl. CPC G01S 19/36; B62J 43/30; B62J 45/41; B62J 45/423; H04B 3/04

(57) ABSTRACT

A vehicle, in particular single-track vehicle, including a front fork suitable for mounting a front wheel, a mudguard attached to the front fork, and a data collection unit with a sensor for collecting data relating to the vehicle and/or the surroundings. The data collection unit includes a satellite signal receiver arranged, preferably substantially centrally, on an upper side of the mudguard in front of the front fork.

### BACKGROUND OF THE INVENTION

The present invention relates to a vehicle, a data collection unit, the use of a data collection unit in a vehicle, and a method for operating a data collection unit in a vehicle.

In the case of vehicles, it has become customary to collect particular data relating to the vehicle and/or the surroundings, such as e.g. the ambient temperature, the speed, the angle of inclination and the position of the vehicle, during the journey, to store them and to transmit them to a computer, a notebook, a smartphone or the like and/or to analyze them.

Further data and/or parameters can be derived from the recorded data, such as e.g. average speeds, elevation profiles, acceleration profiles, distance or route recordings (tracking), in particular also live tracking, or the like.

Data determination units, which comprise sensors and/or receivers for recording the data relating to the vehicle and/or the surroundings, storage units for storing the data, interfaces for transmitting the data and/or computing units for processing the data, are usually provided for the collection of the data.

An accurate determination of position or location is crucial for a high-quality determination of a large amount of these data. The satellite signal receiver is therefore very important.

By satellite signal receiver is meant a unit which usually comprises at least one antenna and a power supply unit.

By means of a satellite signal receiver, in particular through an antenna, signals of a Global Navigation Satellite System (GNSS), for example a Global Positioning System (GPS), can be received.

It has become apparent that the arrangement of the satellite signal receiver on the vehicle is crucial for an interference-free reception of a satellite signal and consequently for an accurate determination of the position of the vehicle.

It is important that at all times the satellite signal receiver is obscured as little as possible by component parts of the vehicle and/or by the rider.

In other words, this means that the space towards the open sky should be as large as possible at all times in order to avoid a shading and/or shielding of satellite signals, for example of GPS signals.

Shading of satellite signals is caused, for example, by the rider bending forwards over the handlebars, which occurs in particular in the case of typical riding behaviour on enduro and/or motocross motorbikes, and/or through the satellite signal receiver being covered by a component part and/or covering element of the vehicle itself.

Tests by the inventor have shown that, in contrast, dirt and the like do not noticeably influence reception of the satellite signal.

Moreover, the satellite signal receiver should be arranged on the vehicle such that it cannot easily be knocked off and/or ripped off and/or the rider is not hampered and/or annoyed by the satellite signal receiver.

Tests by the inventor showed that an arrangement on the back of a vehicle, in particular in the case of single-track vehicles, can be regarded as unfavourable for this.

From the state of the art, data collection units with satellite signal receivers in vehicles are known, such as e.g. from patent specification AT 523996 A1 (KTM AG), which comprises the technical functions of a data collection unit, thus the collection, storage, transmission etc. of data.

However, here, too little importance was attributed to the optimum arrangement of the satellite signal receiver on the vehicle, with the result that in the case of the position of the satellite signal receiver chosen in AT 523996 A1 (KTM AG) the problem of satellite signal shading could arise.

### SUMMARY OF THE INVENTION

The object of the present invention is therefore to provide a generally advantageous arrangement of the satellite signal receiver in vehicles that is improved compared with the state of the art in conjunction with an advantageous design of the data collection unit for vehicles, in particular single-track vehicles such as (e-)motorbikes and/or bikes.

This object is achieved by a vehicle, in particular a single-track vehicle, having:
at least one front fork, suitable for mounting a front wheel,
at least one mudguard, which is attached to the front fork, and
a data collection unit with at least one sensor for collecting data relating to the vehicle and/or the surroundings.

The data collection unit comprises a satellite signal receiver arranged, preferably substantially centrally, on an upper side of the mudguard in front of the front fork.

Protection is also sought for a data collection unit with at least one sensor for the collection of data relating to an, in particular single-track, vehicle and/or the surroundings, consisting of a storage unit and a satellite signal receiver, characterized in that the satellite signal receiver is arranged, preferably separately from the storage unit, preferably substantially centrally, on an upper side of the mudguard in front of the front fork.

Moreover, protection is sought for the use of a data collection unit according to the invention in a vehicle.

Furthermore, protection is sought for a method for operating a data collection unit according to the invention in a vehicle, wherein the satellite signal receiver:
is arranged on the vehicle spatially separated from the storage unit, and
is arranged, preferably substantially centrally, on an upper side of a mudguard in front of the front fork.

The vehicle according to the invention is preferably a single-track vehicle, in particular an (e-)motorbike, such as for example an enduro or a motocross motorbike, or an (e-)bike.

It would also be conceivable for the vehicle to be an (e-)snow motorbike or an (e-)snow bike.

The vehicle has at least one front fork, which comprises at least one fork leg, preferably two fork legs connected by two fork crowns.

The vehicle preferably has handlebars, which are arranged substantially above the front fork.

Depending on the structure of the vehicle, the mudguard attached to the front fork can overlap an upper partial circumference of a front wheel.

It should be mentioned that the mudguard need not be attached directly to the front fork. Indeed, there can be intermediate component parts, via which the mudguard is attached to the front fork.

The mudguard can preferably be attached indirectly or directly to a fork crown of the front fork.

A covering element, such as e.g. a headlight casing and/or a race-number plate and/or a fairing element, for example for encasing a vehicle frame, can be arranged above the mudguard in front of the front fork.

In a preferred embodiment of the invention, the data collection unit has an acceleration sensor and/or a temperature sensor and/or an inclination sensor.

The at least one sensor particularly preferably includes the satellite signal receiver.

The at least one sensor of the data collection unit can additionally collect, for example, the following data relating to the vehicle and/or the surroundings: air temperature, air humidity, speed, acceleration, angle of inclination, engine speed, magnetic field, etc.

Preferably, the data collection unit has a storage unit.

Preferably, the storage unit and the satellite signal receiver are implemented and/or arranged separately from each other.

The particularly preferred division of the data collection unit into a storage unit and a satellite signal receiver has the great advantage that the storage unit and the satellite signal receiver can be arranged on the vehicle beneficially in each case and/or spatially separated from each other.

The satellite signal receiver can be a standalone component part or also be a part of a larger unit, preferably the data collection unit, which in addition to the satellite signal receiver can comprise further sensors and/or a power connection, etc.

The storage unit can be a standalone component part or also a part of a larger unit, preferably the data collection unit.

In relation to the storage unit, an advantageous arrangement on the vehicle is an arrangement at a position which is easily accessible and at the same time protected from external influences.

By external influences can be meant, for example, the rider of the vehicle, another rider, stones, bushes and much more.

However, in general the storage unit can be arranged anywhere on the vehicle.

For example, the area between the fork legs and a covering element of an, in particular single-track, vehicle, in particular in the area between two fork crowns, can be regarded as advantageous for the arrangement of the storage unit.

A further possibility for an advantageous arrangement of the storage unit is in the area around the handlebars.

It is advantageous if the storage unit is arranged in an edge area of the area between the fork legs and a covering element or of the area around the handlebars, with the result that it is easily possible for the rider and/or operator to operate and/or to fasten and/or to detach the storage unit.

It is moreover advantageous that the storage unit does not protrude spatially over the side edges of a covering element but is obscured and/or protected in its entirety by the covering element.

In general, it is also possible to arrange the storage unit inside a further casing, in particular offering protection, wherein the casing can advantageously be arranged on the vehicle and/or is preferably implemented such that the data collection unit, in particular the storage unit, is easily accessible.

In relation to the satellite signal receiver, an advantageous arrangement on the vehicle is as is provided according to the invention.

This means that the satellite signal receiver is arranged on the upper side of a mudguard attached to a front fork and at the same time is obscured as little as possible by the rider and/or by component parts of the vehicle.

Preferably, the satellite signal receiver is arranged centrally above the mudguard.

Preferably, the satellite signal receiver is a subcomponent of a coordinate determination unit, wherein the coordinate determination unit can be fastened and/or is fastened to the vehicle, in particular detachably.

The coordinate determination unit and/or the satellite signal receiver itself can be fastened, in particular detachably, to the mudguard and/or to a component part lying near it, for example a covering element.

For the fastening of the coordinate determination unit and/or of the satellite signal receiver, at least one first fastening device is provided, which is formed to fasten the coordinate determination unit and/or the satellite signal receiver to the mudguard and/or a component part lying near it, for example a covering element.

For the fastening of the storage unit, if it is implemented separately from the satellite signal receiver, at least one second fastening device is beneficially provided, which is formed to fasten the storage unit, in particular detachably, to a fork leg and/or to a fork crown and/or to handlebars and/or a covering element.

The first fastening device and/or the second fastening device are preferably implemented such that the rider and/or the user can fasten the coordinate determination unit and/or the satellite signal receiver and/or the storage unit and/or can detach them from the vehicle themselves.

The first fastening device and/or the second fastening device beneficially comprise in each case at least one strap and/or one tab and/or one loop or the like, in particular with elastic properties, such as for example rubber straps.

Furthermore, the first fastening device and/or the second fastening device can each comprise at least one closure, which is formed to fasten the first fastening device and/or the second fastening device to the vehicle.

It is conceivable that the first and/or second fastening device is formed such that the storage unit and/or the coordinate determination unit and/or the satellite signal receiver can be fastened to an accessory part, for example a bag or a frame element.

It is furthermore conceivable that the first fastening device and/or the second fastening device can also be fastened to the vehicle in a materially bonded manner, for example by gluing, and/or by means of screws.

A further advantage of the preferred separate implementation of the satellite signal receiver and the storage unit is that the arrangement of the satellite signal receiver and of the storage unit can be adapted to the conditions of the vehicle.

By conditions of the vehicle is meant, for example, the geometry of the covering elements and/or of the mudguard and/or of the handlebars and/or of the fork and/or the space available between the race-number plate and/or headlight casing and/or the fork legs and the like.

Thus, there is the possibility, for example, of using the data collection unit for different vehicles.

That also means that the data collection unit can be an accessory and/or retrofit item.

Preferably, the storage unit and the coordinate determination unit and/or the satellite signal receiver are in data connection with each other.

This means that a reciprocal data transmission can beneficially take place between the coordinate determination unit and/or the satellite signal receiver and the storage unit, in particular in relation to the satellite signal data, which can be received by the satellite signal receiver.

The data connection between the storage unit and the coordinate determination unit and/or the satellite signal receiver preferably exists through an, in particular detachable, data cable.

Moreover, the data connection between the coordinate determination unit and/or the satellite signal receiver and the storage unit can be in place wirelessly via a signal, for example by means of a WLAN signal and/or Bluetooth signal, and so forth.

If the data connection between the coordinate determination unit and/or the satellite signal receiver and the storage unit is in place via a wireless signal, preferably the coordinate determination unit and/or the satellite signal receiver and the storage unit are implemented such that they can transmit the data wirelessly, preferably reciprocally.

Preferably, the data collection unit has at least one interface, which is used for the transmission of data from and/or to at least one external transmitter and/or receiver and/or to the control unit of the vehicle.

An external transmitter and/or receiver can, for example, be a computer and/or a smartphone and/or a tablet and/or a notebook and/or a server.

For the transmission of data to an external transmitter and/or receiver, in particular a wireless data transmission by means of at least one signal is provided.

However, a detachable data cable can also be provided for the transmission of data to an external transmitter and/or receiver.

For the transmission of data between the vehicle and the data collection unit, a data cable is preferably provided.

In this context, it is advantageous to arrange the storage unit in the vicinity of the vehicle's data connection.

The data connection of a single-track vehicle is preferably located in the area underneath the handlebars and/or in front of the front fork, in particular in the area of the fork crowns.

The data collection unit can have at least one light, in particular for indicating states relating to the vehicle and/or relating to the data collection unit.

Furthermore, the storage unit has a memory which can store data relating to the vehicle and/or the surroundings.

The memory can store external data and/or the data received by the data collection unit by means of the sensors and/or the satellite signal receiver.

The storage unit preferably has at least one switch, which is used at least to switch the data collection unit on and/or off.

It is also conceivable for the at least one switch to have a reset function and/or a control or regulation function.

It is also conceivable for the at least one switch to have functions which influence the function of the data collection unit.

Preferably, the data collection unit is switched on by the at least one switch at least when first used.

Preferably, the data collection unit has at least one detachable power connection to the vehicle, which is in place in particular during the operation of the data collection unit.

This means that preferably a power cable is connected to the data collection unit, in particular to the storage unit, and to the vehicle during the operation of the data collection unit.

It is possible that the data collection unit has an energy storage device, which is connected to the vehicle and/or to an external power source, in particular temporarily, by a detachable power connection.

Preferably, the coordinate determination unit and/or the satellite signal receiver and the storage unit are detachably connected to each other by a power cable.

It is also possible that the coordinate determination unit and/or the satellite signal receiver and/or the storage unit have an energy storage device and/or a detachable power connection.

If the coordinate determination unit and/or the satellite signal receiver and the storage unit are connected to each other wirelessly by means of a signal, it can make sense for the coordinate determination unit and/or the satellite signal receiver and the storage unit to each have an energy storage device and a detachable power connection.

Preferably, the data collection unit has at least one transmission device, in particular comprising at least one cable input and/or one cable output, for the transmission of power and/or data relating to the vehicle and/or data relating to the surroundings.

Preferably, the data collection unit comprises transmission devices for sending and/or receiving the data and/or the power.

By transmission devices can be meant cable inputs, cable outputs, antennas, emitters or the like.

Preferably, the data collection unit, preferably the storage unit, has at least one computing unit, which is suitable for processing and/or analyzing the collected data and/or for regulating or controlling functions of the data collection unit.

In a preferred embodiment of the invention, the at least one computing unit can be used for compiling statistics from the collected data and/or the data received from the vehicle.

The computing unit can be used for the exchange of data with a program and/or an application, such as e.g. a piece of software on a computer and/or an app on a smartphone.

A program and/or an application, in particular a smartphone app, can be utilized, in particular by means of the computing unit, to operate, in particular for the configuration of, the data collection unit.

Moreover, a program and/or an application, in particular a smartphone app, can be used to represent, in particular graphically and/or in tabular form, the data collected and/or processed and/or analyzed by the data collection unit.

The representation of the data can be utilized, for example, to analyze a journey with a vehicle according to the invention and/or to compare it with at least one other journey.

Preferably, the method for operating a data collection unit comprises the following method steps, in particular if the storage unit and the satellite signal receiver are implemented separately from each other:
the spatial arrangement of the storage unit above the mudguard, in particular in the area between the at least one fork leg and/or a covering element, and/or
the, in particular detachable, fastening of the storage unit to the vehicle, in particular to a fork leg, and/or
the, in particular detachable, fastening of the coordinate determination unit and/or the satellite signal receiver to the vehicle, in particular to the upper side of the mudguard, and/or
the production of the at least one, in particular detachable, connection, in particular of the data connection and/or of the power connection, between the coordinate determination unit and/or the satellite signal receiver and the storage unit, and/or
the production of the at least one, in particular detachable, connection, in particular of the data connection and/or of the power connection, between the data collection unit and the vehicle, and/or
the production of the at least one, in particular detachable, connection, in particular of the data connection and/or of the power connection, between the data collection unit and an external device, and/or
the actuation of the switch, at least on first use after the connection of the power connection of the storage unit and/or of the power connection of the coordinate determination unit and/or of the satellite signal receiver, with the result that the data collection unit is switched on, and/or
the production of the data connection between the data collection unit and a program and/or an application, at least when first used after the connection of the power connection of the storage unit and/or of the power connection of the coordinate determination unit and/or of the satellite signal receiver, and/or
the configuration and/or the adaptation of the data collection unit, in particular with the aid of a program and/or an application, at least when the data collection unit is first used.

### BRIEF DESCRIPTION OF THE DRAWINGS

Further advantages and details of the invention are revealed by the figures and the associated description of the figures. There are shown in:

FIG. 1 shows an embodiment of a vehicle according to the invention,

FIG. 2 shows subcomponents of a vehicle according to the invention,

FIG. 3 shows an embodiment of a data collection unit, and

FIG. 4 is a view of a storage unit on a fork leg.

### DETAILED DESCRIPTION OF THE INVENTION

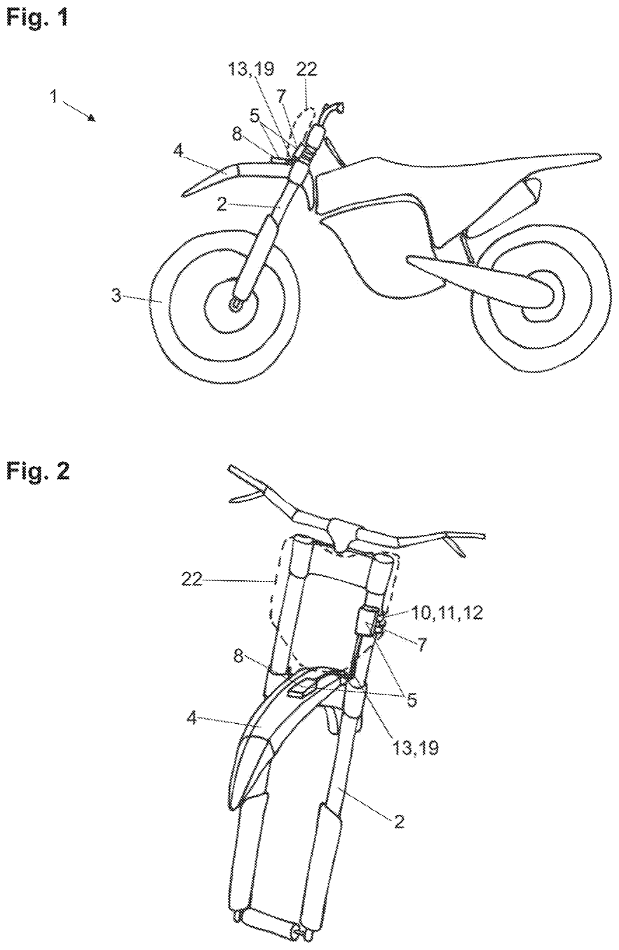

FIG. 1 shows a side view of an embodiment of a vehicle 1 according to the invention, in which the satellite signal receiver 8 is fastened to the upper side of the mudguard 4 and beneficially a storage unit 7 is fastened to the front fork 2.

As it is also possible that the vehicle 1 is not a motorbike but rather a snow motorbike, (e-)bike or a snow (e-)bike, a front wheel 3 is not necessarily present. However, in particularly preferred embodiments a front wheel 3 is present.

One task of the satellite signal receiver 8 is to receive and/or analyze satellite signals, for example GNSS signals.

It is particularly preferably provided that the satellite signal receiver 8 transmits the collected satellite signal data to the storage unit 7, where a further data storage and/or processing is effected.

The data collection unit 5 is formed to transmit the collected satellite signal data to an external device, where a further data storage and/or processing can be effected.

The embodiment moreover shows an advantageous arrangement of the storage unit 7 in an area protected from external influences, in particular behind a covering element 22, preferably between the covering element 22 and the front fork 2.

However, the storage unit 7 can e.g. also be arranged in the area around the satellite signal receiver 8.

It is also conceivable for the satellite signal receiver 8 and the storage unit 7 to share a common casing.

Due to the preferred detachability of the first fastening device 9 of the satellite signal receiver 8 and of the second fastening device 10 of the storage unit 7, in particular if the latter is present and is implemented separately, an optimum arrangement in terms of the protection provided and/or ease of fastening and/or adaptation to the geometry of the mudguard 4 and/or covering element 22 is possible.

FIG. 2 shows subcomponents of a vehicle 1 according to the invention, wherein the satellite signal receiver 8 is arranged on and/or fastened to the upper side of the mudguard 4 centrally.

In this regard, an arrangement in the vicinity of a covering element 22 is advantageous, with the result that there is at least a partial protective effect against external influences.

In any case, it is particularly advantageously provided that the shading of the satellite signal receiver 8 by subcomponents of the vehicle 1 and/or by the rider is also as small as possible.

It is also possible that the satellite signal receiver 8 is arranged on and/or fastened to a covering element 22.

As can be seen in FIG. 2, the arrangement of the storage unit 7 is particularly preferably on a fork leg substantially above the mudguard 4 and/or between the two fork crowns.

Thus, the storage unit 7 is beneficially easily accessible and can be easily fastened and/or detached and/or operated.

Furthermore, due to this preferred arrangement it is easy to reach the at least one transmission device 20 and/or the power connection 18 and/or the at least one interface 14 and/or the switch 17, and/or to see the at least one light 16.

The data cable 13 that is connected between the storage unit 7 and the satellite signal receiver 8, and/or the power cable 19, is preferably arranged such that it is at least partially protected from external influences.

Furthermore, the length of the data cable 13 and/or of the power cable 19 is preferably provided such that a simple detachable attachment of the data collection unit 5 is possible, in particular matching the geometry of the vehicle 1 and/or of the mudguard 4 and/or of the fork 2 and/or of a covering element 22 and/or the position of the storage unit 7 and/or of the satellite signal receiver 8.

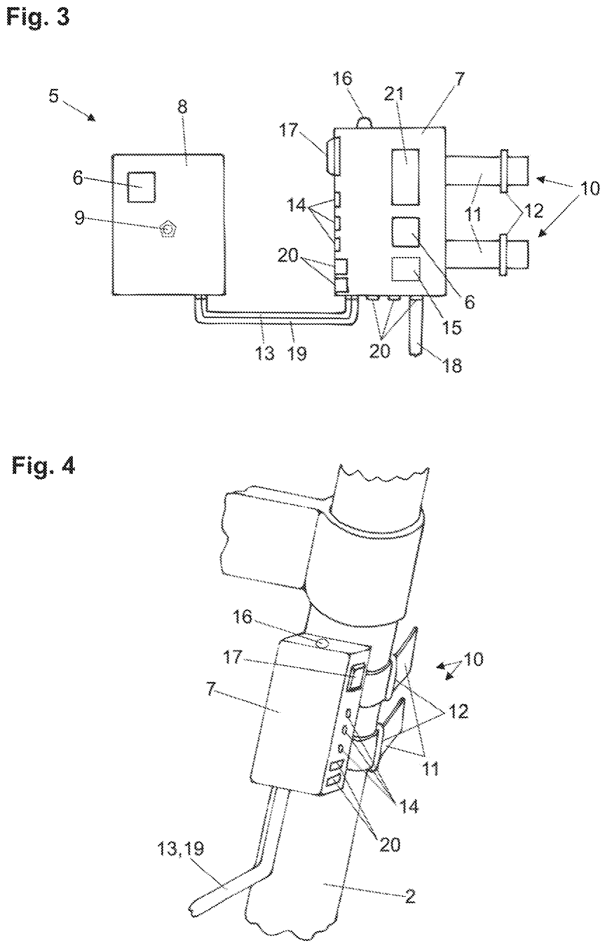

FIG. 3 shows an embodiment of a data collection unit 5 beneficially with a storage unit 7, wherein the storage unit 7 and the satellite signal receiver 8 are implemented separately from each other and are connected to each other by a data cable 13 and a power cable 19.

Alternatively, when the satellite signal receiver 8 and the storage unit 7 are implemented separately, a data collection unit 5 without a data cable 13 is possible, wherein the data transmission is effected by means of a signal.

In the case of a transmission of data by means of a signal, at least the arrangement of at least one further transmission device 20 and/or of at least one interface 14 on the satellite signal receiver 8 is provided.

Furthermore, a data collection unit 5 without a power cable 19 between the storage unit 7 and the satellite signal receiver 8 is possible.

For this, at least one energy storage device and one power connection 18 on the satellite signal receiver 8 is beneficially provided.

Moreover, FIG. 3 shows a power connection 18, which is advantageously formed to be detachably connected with a cable to a vehicle 1 and/or to an external power source.

It is particularly preferably provided that, while the vehicle 1 is being used, the power connection 5 is connected to the vehicle 1 with a cable, with the result that the data collection unit 5 draws power from the vehicle 1.

Alternatively, it is possible for the data collection unit 5, in particular the storage unit 7, to have an energy storage device.

If the data collection unit 5 has an energy storage device, it is provided that the power connection 14 is at least temporarily connected to a vehicle 1 or to an external power source.

The power connection 18 preferably comprises a cable for the power transmission.

However, cable-free and/or inductive mechanisms are also conceivable for the power transmission.

In this embodiment the at least one first fastening device 9 of the satellite signal receiver 8 is at least one screw.

However, other fastening means are also possible, such as for example at least one strap 11, preferably with at least one closure 12 and/or a materially bonded connection, e.g. with the aid of an adhesive.

The at least one second fastening device 10 of the storage unit 7, in particular if the latter is present and implemented separately, is particularly preferably a, preferably elastic, strap 11 with a closure 12.

However, other fastening means are also possible, for example comprising at least one moulded part and/or at least one clamping element and/or at least one screw and/or at least one spring.

In this embodiment, the storage unit 7 and the satellite signal receiver 8 themselves are fastened to the vehicle 1.

However, it is also possible for the storage unit 7 and/or the satellite signal receiver 8 to be arranged inside a casing, wherein the casing is fastened to the vehicle 1.

FIG. 3 furthermore shows at least one sensor 6, which can be implemented as part of the satellite signal receiver 8 and/or of the storage unit 7.

The at least one sensor 6 can be any type of sensor, wherein it is in particular formed for the collection of data relating to the vehicle 1 and/or the surroundings that are required for an analysis.

The at least one preferred light 16 is particularly preferably arranged on the storage unit 7 but can be located anywhere on the data collection unit 5.

It is also possible for there to be several lights 16, which relate to different items of information and/or functions and/or light up differently.

The at least one preferred switch 17 is preferably arranged on the data collection unit 5, preferably on the storage unit 7, such that it can be easily actuated.

Preferably, at least one light 16, at least one switch 17, at least one interface 14, at least one transmission device 20 and at least one power connection 18 are arranged on the storage unit 7, wherein the latter is then preferably fastened to the fork leg due to the better accessibility and/or better visibility.

As can furthermore be seen in the embodiment of FIG. 3, the at least one memory 15 is particularly preferably arranged in the storage unit 7.

Furthermore, the preferred computing unit 21 is particularly preferably arranged in the storage unit 7.

It is also conceivable for the at least one memory 15 and/or the computing unit 21 to be arranged in the satellite signal receiver 8.

### LIST OF REFERENCE NUMBERS

1 vehicle according to the invention
2 front fork
3 front wheel
4 mudguard
5 data collection unit
6 sensor
7 storage unit
8 satellite signal receiver
9 first fastening device
10 second fastening device
11 strap
12 closure
13 data cable
14 interface
15 memory
16 light
17 switch
18 power connection
19 power cable
20 transmission device
21 computing unit
22 covering element

1. A vehicle, in particular single-track vehicle, comprising:
at least one front fork suitable for mounting a front wheel,
at least one mudguard attached to the front fork, and
a data collection unit including a sensor for collecting data relating to the vehicle and/or the surroundings,
wherein the data collection unit further includes a satellite signal receiver arranged, preferably substantially centrally, on an upper side of the mudguard in front of the front fork.

2. The vehicle according to claim 1, wherein the satellite signal receiver is fastened above the mudguard and/or to the mudguard, preferably detachably.

3. The vehicle according to claim 1, wherein the satellite signal receiver has at least one first fastening device, which is formed to fasten the satellite signal receiver above the mudguard and/or to the mudguard, preferably detachably.

4. The vehicle according to claim 1, wherein the data collection unit has a storage unit.

5. The vehicle according to claim 4, wherein the storage unit and the satellite signal receiver are implemented and/or arranged separately from each other.

6. The vehicle according to claim 4, wherein the storage unit has at least one second fastening device, which is formed to fasten the storage unit to the vehicle, preferably detachably.

7. The vehicle according to claim 6, wherein the at least one second fastening device is formed to fasten the storage unit to a front fork, in particular to a fork leg, preferably detachably.

8. The vehicle according to claim 4, wherein the storage unit and the satellite signal receiver are in data connection with each other, preferably through a detachable data cable, in particular for the reciprocal transmission of collected data.

9. The vehicle according to claim 1, wherein the data collection unit has an interface for transmitting external data and/or the collected data and/or data received from the vehicle, in particular for transmitting data to an external receiver and/or for receiving data from an external transmitter.

10. The vehicle according to claim 9, wherein the interface is formed for the wireless transmission of data, in particular in accordance with the WLAN standard and/or Bluetooth standard.

11. The vehicle according to claim 4, wherein the storage unit has at least one memory for storing the data collected by the satellite signal receiver and/or the at least one sensor and/or the externally received data.

12. The vehicle according to claim 1, wherein the data collection unit has at least one detachable power connection to the vehicle and/or to a power source.

13. The vehicle according to claim 4, characterized in that the storage unit and the satellite signal receiver are connected to each other by a power cable, in particular detachably.

14. A data collection unit comprising:
at least one sensor for collecting of data relating to a vehicle and/or the surroundings,
a storage unit, and
a satellite signal receiver, wherein the satellite signal receiver is arranged, preferably separately from the storage unit, preferably substantially centrally, on an upper side of a mudguard of the vehicle in front of the front fork of the vehicle.

15. A use of a data collection unit according to claim 14 in the vehicle.

16. A method for operating the data collection unit according to claim 14 in the vehicle, comprising:
arranging the satellite signal receiver on the vehicle spatially separated from the storage unit, and, preferably substantially centrally, on an upper side of the mudguard in front of the front fork.
